(19) United States
(12) Patent Application Publication
(10) Pub. No.: US 2008/0062625 A1
(43) Pub. Date: Mar. 13, 2008

(54) Portable computer for dual, rotatable screens

(76) Inventor: Jeffrey Batio, San Diego, CA (US)

Correspondence Address: Welsh & Katz, Ltd.;Daniel M. Gurfinkel, 22nd Floor, 120 South Riverside Plaza, Chicago, IL, 60606, US

(21) Appl. No.: 11/804,367

(22) Filed: May 18, 2007

Related U.S. Application Data
(63) Continuation of application No. 09/690,799, filed on Oct. 17, 2000, now abandoned.
(60) Provisional application No. 60/160,001, filed on Oct. 18, 1999.

(51) Int. Cl. G06F 1/16

(52) U.S. Cl. 361/680; 361/681

(57) ABSTRACT

A portable computer having a independently mounted screen sections, whereby the screen sections may be used to provide a larger overall screen, to provide screens mirroring each other for presentation and display, for use by different users, and the like. The screen sections are foldable and collapsible into the main housing of the portable computer for storage and transport.

### BACKGROUND OF THE INVENTION

The present invention is a system of computing is based upon a proprietary design comprised of a hinged base unit and pivotally mounted dual independent displays that provide the foundation of the system. (The other folding units need to be incorporated into this language-also add the latest folding designs) The unique design allows the machine to be much more than the sum of its parts. Thanks to the invention, the unit is capable of providing all of the working benefits of a full-sized desktop workstation that collapses via folding into a portable form factor. The unit functions equally as well in the unique dual (side by side) portrait screen modes as it does in the more traditional landscape modes, though it is the unique case design/s that allows it to do all of this in a convenient and stylish self contained unit.

Though Larger units can be made, the marketing direction of the design of the units also indicates that a comprises a minimum of two smaller variations on the theme shall be produced. The first is known as the Flip-Pad Vector™ a mid-sized unit that travels in the same sized package as a small notebook or sub-notebook, but opens to provide approximately 17″ or so, display area and a full-sized keyboard.

The Stealth™ is the Flip-Pad that folds to travel in the size of a handheld PC, yet opens to give the user a full-sized keyboard and a much larger screen (11-12″) than is currently available in the handheld market.

The Nomad™ is the Company's folding full-sized keyboard and mobile expansion device that also can expand to be a mobile wireless Internet browser. The Nomad is comprised of the folding base unit without the screens. The unit folds closed in the opposite way to protect the keyboard halves. This enhanced mobile expansion device with a keyboard interface also interfaces with the full-fledged PC versions to allow for multiple users and interaction.

The Future of Computing™ is here today. The revolutionary form factor provides for a host of additional advantages for the existing computing market and the emerging TeleComputing™ markets, as is described below:

### Screen Applications

The deluge of information that we receive daily and need to sift through in the digital world today is overwhelming to say the least. With the advent of Microsoft Windows 95/98, users can effectively multi-task by simply opening more than one program on-screen and simultaneously share data between the programs. Such as the act of inserting a digital image into a text document, or for example, Microsoft Office Suite users frequently create spreadsheet data in Microsoft Excel (charts and graphs) and then need to cut and paste that information into Microsoft Word in order to create complete documents. Due to the single screen nature of most PC setups, the user has to shrink each program window down significantly in order to highlight and then share the information between the program windows.

Additionally, since most computer setups feature one screen mounted in landscape (a rectangular viewing area mounted horizontally), most of the on-screen document (a piece of paper is 8.5″×11″) is lost and the user is forced to “scroll” the document down to read the entire page of text.

To remedy the landscape portion of this problem, many of today's desktop-bound LCD monitors can pivot on a frame-mounted hinge to physically rotate the screen from the inefficient landscape orientation to the far more useful and productive Portrait or vertical mode. Since most computing work requires document creation, and in most of the world a standard document is 8.5″×11.0″ (portrait) the portrait re-creation of the image onscreen saves the user considerable time and effort from not having to constantly reposition (scroll-down) the image onscreen to read a full page of text.

Moreover, due to the inefficiencies that the single monitor screen provides, it is deemed a poor source for adding multiple Windows and dragging information between them as compared to multiple individual displays that run the individual applications full-screen per monitor. Microsoft likely sees this as a fact since they have since designed internal operating system software support (drivers, etc.), commencing with the release of Windows 98™ that allows for multiple (up to 9 displays) to run as one large contiguous on-screen desktop. While this is an advantage, there is currently no way to benefit simultaneously from the advantages of multiple displays and the advantages provided by portrait display mode, joined in a portable form of computing, until now. This value is present whether either of the displays rotates 360 degrees, 180 degrees or neither rotates at all. This is key to point out, because the primary benefit of the dual displays is the increases gained in useable on-screen real estate, the travel benefits of two independent folding displays and the advantages in screen resolution when two displays resolutions are multiplied.

The Xentex™ Flip-Pad™ Quad-Fold™ architecture of the present invention provides a portable dual portrait screen solution to address all these issues, whilst bringing about other additional and beneficial advancements to the computer user. Advancements that are not currently known in the market, as is described in detail below.

### SUMMARY OF THE INVENTION

### Screen Overview

The Large version of the Flip-Pad system (code name: Voyager™) of the present invention has two built-in 14″ or 15″ Liquid Crystal Displays (LCD) mounted in portrait mode (side by side). There are approximately 3-4 mm between each screen. On screen the two LCDs act as one large display area, and are equivalent to a contiguous 23″ LCD. For reference there are currently no 23″-25″ LCDs available in the world, since a single 23″ display is too difficult to build and manufacture at a marketable cost. This is because LCDs are constructed of two glass substrates with the electronics sandwiched between them. As such, due to the inherent physical properties of glass, they are too fragile to travel with and also frequently suffer from ever-larger unacceptable levels of dead pixels. They are also obviously not portable due to the size and flexing loads suffered by one large panel, etc. For example, The benefit of the two 14″-15″ (or larger or smaller) LCDs mounted side-by-side, act as a full 23″-25″ LCD when the two LCDs are operating in the contiguous mode of operation. The resolution of the two displays together is now 1,024×1536 pixels. (Note: the current resolution limitations each LCD in landscape mode is 1,024×768 and when these are increased by the manufacturers design, the resolution still always multiplies by two on the Flip-Pad design.).

This allows a user to have a simulated/real 23″ LCD that under current constraints had not been possible, before the Flip-Pad design. The benefits and increase in efficiency and productivity escalates significantly to the end user.

The unique feature of the basic system design is the ability to use the two internal displays in the system in several different ways. This is a user experience that is totally new to the industry. The following methods of usage are:
a. Virtual Desktop: In this mode, the end user uses the screen as a huge 23″ LCD equivalent. This is defined as using the two dual displays to represent the data onscreen much like one large monitor. The only difference in usage between a single large display and the usage in this mode is the very small physical separation between the two displays.
b. Mirror Mode: Is defined as mirroring the image on one screen to the other.

This is defined as the two displays exactly match what is on one screen with the other. The advantage of this is when you physically rotate one of the screens 180-degrees from the other, you can then present your work to others sitting opposite you.
c. Independent Display Mode: This is defined as when the user operates the two displays as totally separate and independent monitors. One usage is two people using the system via an additional keyboard and mouse plugged into the system, and then actually doing their own work simultaneously on the single system. This is also very beneficial when tied to the fact that for the first time in a self contained pre-configured portable, the user can run multiple operating systems simultaneously. For instance, currently Users can run a laptop with either Windows or LINUX. To run one or the either on the same machine requires the User to reboot the machine. In the case of the dual screen Flip-Pad and the advantage of the Dual Boot system described on page 34, of this application, the User can run both Operating Systems simultaneously for the first time. This is of substantial benefit to Users running applications in both environments and is also useful for side-by-side comparisons of the O/S's in question

### BRIEF DESCRIPTION OF THE DRAWINGS

The invention will be more readily understood with reference to the accompanying drawings, wherein:

FIGS. 1A-1D show the first embodiment of the invention with a hand-held portable computer of the present invention having a double touch screen pivoted together along opposite horizontal edges;

FIGS. 2A-2E show a second embodiment of the invention with a double screen monitor pivoted together along opposite vertical edges;

FIGS. 3A-3D show a third embodiment of the invention with a double screen monitor pivoted together along opposite horizontal edges to form a Z-form;

FIGS. 4A-4D show a fourth embodiment of the invention showing a portable computer that may be used as a stand for a desk top with removable keyboard;

FIGS. 5A-5C show a fifth embodiment of the invention with a double screen monitor pivoted together along opposite horizontal edges which may be used for a presentation;

FIGS. 6A-6E show a sixth embodiment of the invention showing a screen that may assume a number of different positions.

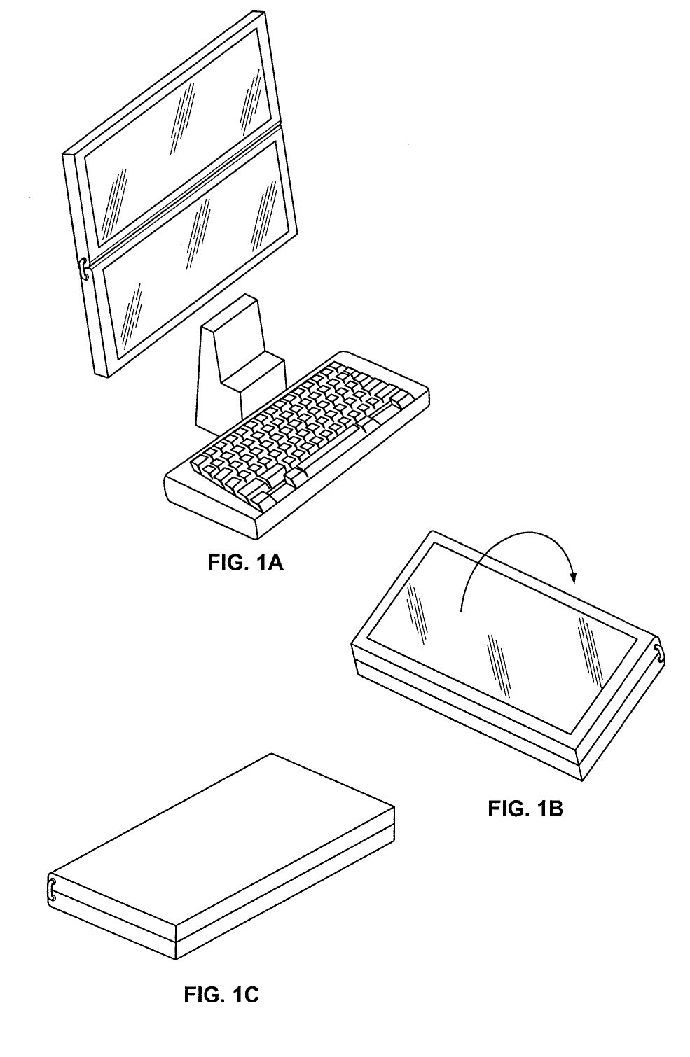

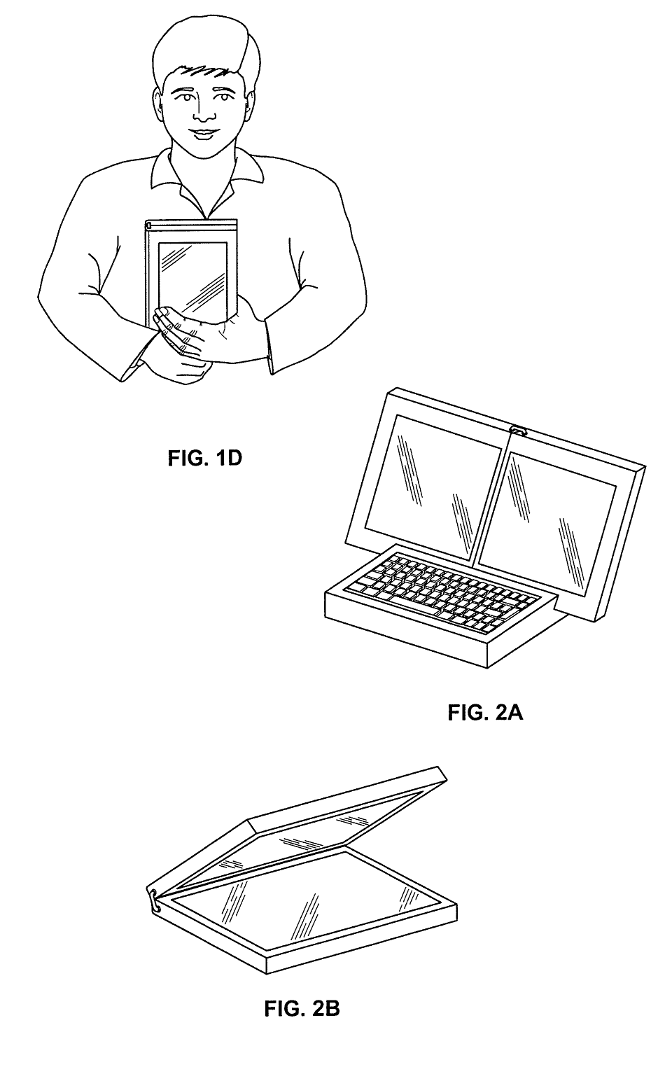

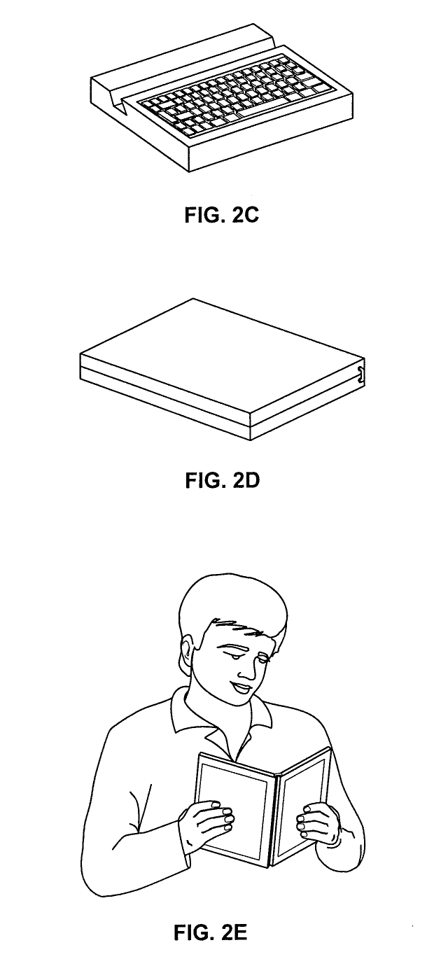

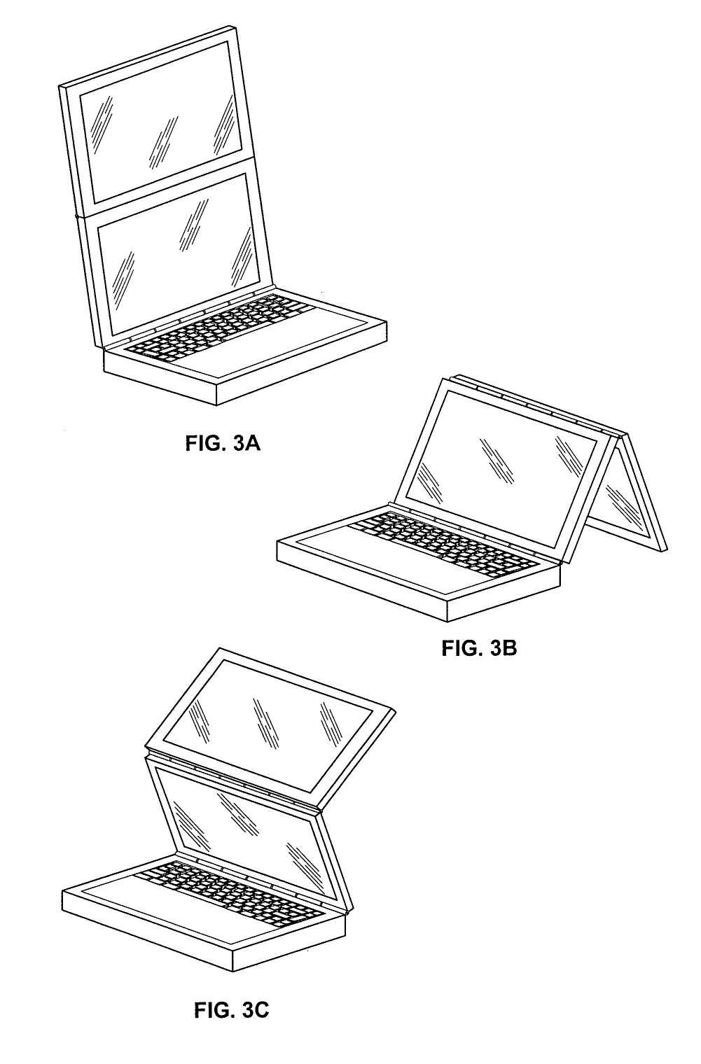

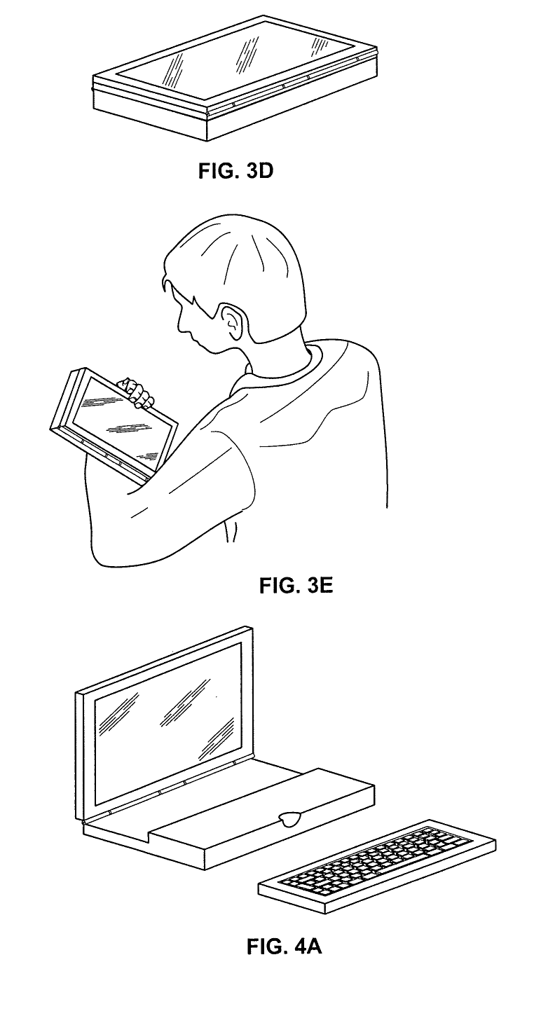

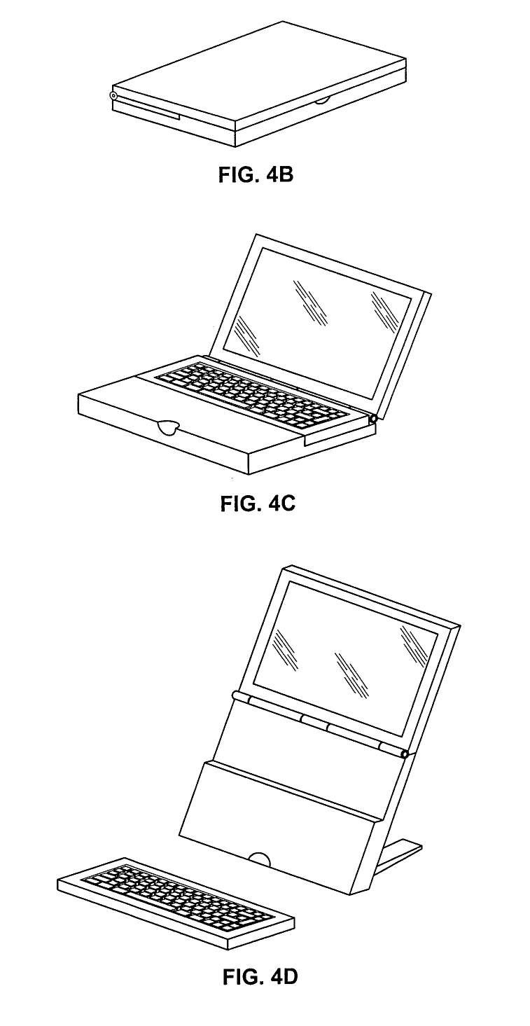

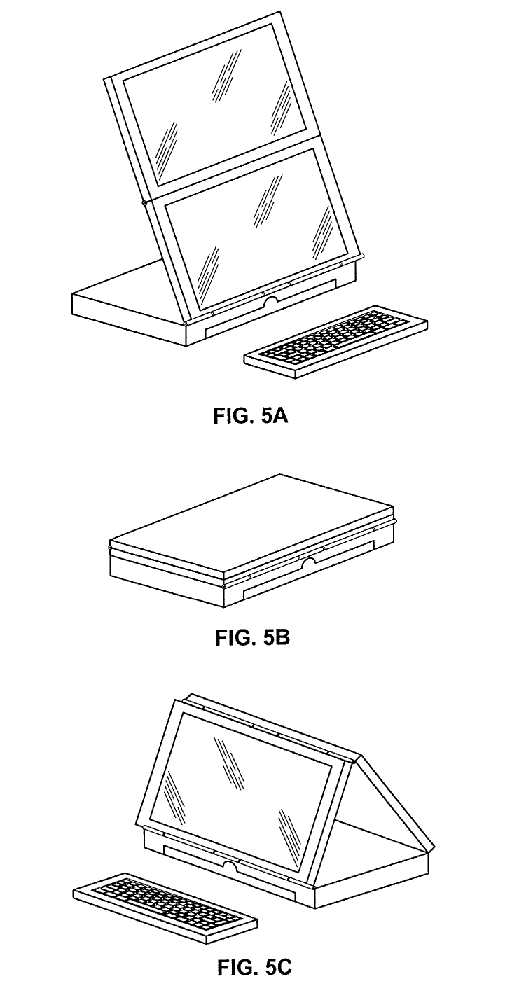

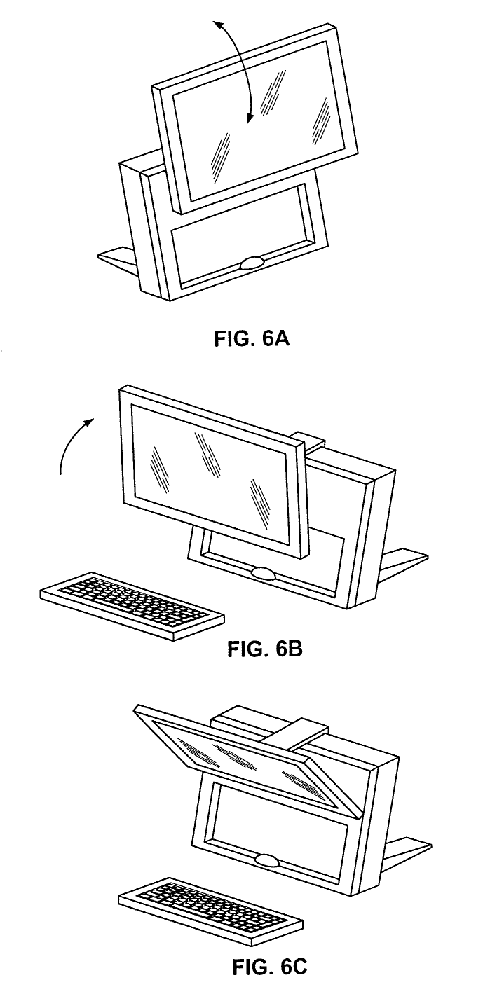

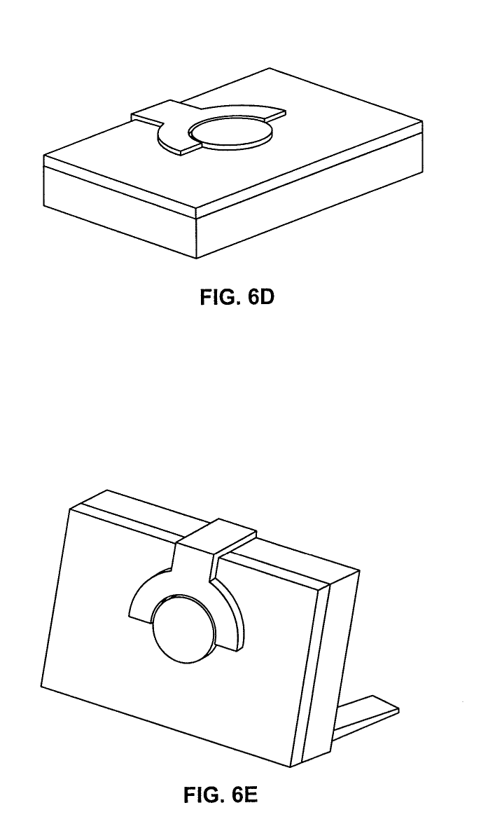

### DETAILED DESCRIPTION OF THE INVENTION

### Detailed Description of Screen Uses

Portable Dual Displays in Portrait Mode:

Due to the multiple levels of efficiencies of data management and manipulation provided by standard dual display technology, it is currently well known and practiced throughout the industry. What is currently unavailable and unknown, is dual displays functioning seamlessly in dual portrait mode in a portable self contained pre-configured setup. Portrait is defined as rotating the traditionally landscape (horizontally mounted) display into the vertical orientation. Currently no known product offers dual displays recognized as one large display in portrait mode. The Flip-Pad™ provides the screen real estate solution in a portable form factor, whilst also utilizing the screen resolution far better than currently available LCD technology as is described below. Furthermore, there is no known dual display technology available in a portable form factor, whether portrait or landscape.

Portrait Presentations:

Due to the additional screen real estate provided by the portrait orientation of the screens, the ability to present computer generated information and/or slides is enhanced beyond traditional landscape orientated slides. Since most text must reference the standard 8.5″×11.0″ portrait orientation of a standard page of text, the presenter gains significant room for more room for text per slide thus reducing the number of slides required per presentation, and also provides for more room for pictures and illustrations along with the required text.

Resolution Enhancements:

Screen resolution cannot seem to be high enough for many computer-using professionals. The higher the resolution (number of viewable pixels) the clearer the onscreen image appears while also providing more useable onscreen image space on the same size panel. This is easy to demonstrate by simply changing the resolution in the monitor settings properties of any PC up or down to illustrate the point.

As stated, the higher the resolution, the more desirable and useful the monitor solution. Current LCD technology is limited in its ability to reproduce image resolution-much beyond XGA resolution of 1,024×768 pixels. This has hampered the adoption of LCD technology by the workstation users, whose work typically requires the higher resolutions.

The Flip-Pad resolution is greatly increased as a direct result of taking the standard displays and rotating them into portrait, and utilizing the two smaller displays as one large workspace. By doing this, the unit achieves an on-screen viewing resolution superior to the currently available LCD panels on the market. Traditional single display mounted in the landscape mode can currently achieve resolutions of 1,024 horizontal viewable pixels ×768 vertical viewable pixels, by rotating both displays to portrait (the vertical is now 1,024) and then combining their existing (768) resolutions, the displays provide a combined viewable resolution of 1,536×1,024 a resolution that is currently unachievable with LCD panels today.

Multiple (Up to Four) External Display Support:

Thanks to the unit's inherent ability to display and rotate, the onscreen images from the native landscape mode of Windows and Windows based applications in the systems hardware circuitry via the dual dedicated video chips (or custom designed integrated circuit chip that combines the functionality of the two or more separate chips into one single chip), the unit can additionally run two more external displays for a total of four. This adding to the original two onboard displays, that combined functions as one contiguous desktop display. This ability to present ever more screen real estate to the user is of significant and novel benefit with universal appeal. For example, securities traders never seem to have enough screen real estate to run their multiple applications and they certainly do not have a portable option-now they do.

The Flip-Pad's dedicated video architecture has the ability to support two additional external monitors (portrait and or landscape) for a total of four displays as one large desktop (as described below). Under this configuration, the unit provides maximal resolution of 1,024×3,152. This is a resolution that is unheard of in either the desktop CRT or LCD realm and wont be available for many years. This is due in part to the unique physical design of the system and its ability to minimize to almost non-existent levels, the gap between the displays.

Video Conferencing and White-Boarding:

The ability to have two displays adds further value to the end user that is seeking to use the system as a video-conferencing system. This system will put the video image of the remote communicator full-screen, while the document that is being collaborated on, is full-screen on the other display so that each user may remotely work on the document.

Mobile Video Camera Interface with Teleprompter & Editing Functions:

The unit will be able to further enhanced via the ability to plug a camcorder into the back of the unit and allow for easy video editing. In this incarnation, the user can easily edit full-screen the incoming source into the edited source full-screen. Furthermore, the user can rotate the display and stand at the back of the unit and view themselves in the shot full-screen. This is of great advantage to video users, since the reason that the LCD panels common on most portable camcorders today, are there so that the operator can place the camcorder on a tri-pod and then flip the screen over to spot themselves in the shot. Obviously the larger the screen the easier it is to see and line up the shot.

The next advantage under this system is that a user can be typing the text to be spoken on the unit's keyboard, and then is reproduced on the rotated display so that the person speaking the text in the filmed shot and can easily see themselves and read the text onscreen. Once completed, the footage can be easily edited and assembled into complete footage. This is more efficient when the user installs the video editing key-slabs in place of the removable standard alphanumeric keyboards (as is described further in the keyboard section of this document).

Health Benefits and Desk Space Savings:

Current CRT's monitors emit electromagnetic radiation from the front of the monitor towards the computer user. Conversely, LCD monitors do not. LCD monitors are far healthier for the user to operate and also cause far less eye fatigue since they are not prone to the onscreen image flickering of CRT technology. Currently no workstation user can benefit from the advantages of a Mobile Workstation™ and gain the safety and health benefits provided by LCD technology due to the resolution limitations. The Xentex Flip-Pad solves this dilemma.

Furthermore, LCD panels are far smaller and lighter and require far less electricity to operate and are thus more ecologically sound in design. The CRT monitor, provides the resolution solution but at the expense of portability, safety, ecology and desk space. The Flip-Pad Quad-fold™ architecture remedies this for all.

### Screen Usage

### Stationary or Rotation for Added Functionality

The system is designed to function as the first portable dual portrait display full featured computer. That need not have any of the displays rotate to provide the majority of the functionality described herein. However when on or more of the displays rotate through a range of 0-180 minimum, an additional level of unique and novel functionality benefiting the operator of the system is imparted. In this regard, The system is configured to allow multiple levels of screen usage via the rotating hinge/s. The primary incarnations are:
1). One user rotates one of the displays 180-degrees to present the screen area to others sitting opposite the primary user who is controlling the device.

2). Two users to each using an individual screen at the same time. In this mode two users could be either are using the system with each both displays facing them while facing each other across the base of the unit and each having a separate keyboard and pointing device and or using the onscreen stylus capability. In other words the two users are interacting on one system while on opposite sides of the system and facing each other. This is accomplished by setting the system up in the standard operational mode with both displays facing the primary user, after which, one of the displays is rotated to face the rear of the unit. At which point the second User sits opposing to the first user and then plugs in the necessary input devices via the ports on the back of the machine. Thus allowing for independent or linked usage of the machine.
3). In this configuration, The screens are both rotated a minimum of 180-degrees for rear facing full-screen presentation. They then can be folded back down upon the base. This allows several other configurations:
   a). As one big tablet, this is characterized by having both displays rotated and then folded flat upon the base.
   b). The base unit can then be folded in half at the base hinge to provide for dual opposing screens in landscape orientation.

Rotatable Display/s:

Today the acronym PC stands for Personal Computer. Translation: a single screen computer limits the inability for two users to work together, interact, or present data to each other efficiently on the one traditional single screen PC. Thus rendering it more of an impersonal PC.

U.S. Pat. No. 5,949,643 calls for one of the displays to be rotatable 360-degrees for convenient displaying of the on-screen image to whomever is within the viewing area creating the first iPC™ or Inter-Personal Computer™. To achieve the other uses of the unit, only one display can/should be rotated, and only 180-degrees. This allows for several new and proprietary applications:

Two Users on One PC:

There is currently known add-in PC video card technology that allows current PC's to utilize the copious amounts of processing power and allow two or more users to share on PC and CPU (Central Processing Unit), and modem/Internet connection via this sharing or networking solution. The known technology is provided via a plug-in video card that has two video chips and a port on the back for an included signal splitting box. This card is installed in the desktop (not mobile) PC and then the splitter box is plugged into the external port on the outside face of the card. The splitter box provides additional standard ports for the traditionally required additional monitor, keyboard and pointing device (mouse, track ball, etc.). Upon successful installation, the users can boot up the PC and can then log on as individual users and even share an internet/modem connection to surf the web simultaneously or run applications independently. Per screen, users can even set up individual preferences per screen like wallpaper, icon size and style, etc., just like it truly were two separate and independent PC units. The value is that one PC can now service two or more users simultaneously (up to four with the right hardware configuration). The value propositions are obvious, as one household or workgroup can save the money of separate additional PCs and printers, etc. In fact, you can collaborate together as if it were a mini-networked environment. The only major drawbacks to this solution are:
1) The cost of having to buy the additional separate hardware: monitor, keyboard, mouse, etc.
2) The configuration is certainly not a portable solution.

The current existing desktop PC solutions do not support individual sound.

The Flip-Pad of the present invention brings the advantages and value of multiple users (up to four with the addition of two separate monitors as is described below) on one primary base unit. This is accomplished via the built-in dual displays that rotate (either one or both). This way the unit provides for the existence of a portable two-user platform for head-to-head Computing™ that allows for real-time collaboration and independent computing. Furthermore, since the unit's individual displays are in close proximity to the base unit, and the base mounted speakers can be easily heard. Additional speakers can be mounted in the individual display halves, so that sound can finally be reproduced per user. In fact, the sound signals can be split per side per user so that simultaneous sound can be reproduced. The unit can also feature dual audio input and output jacks for separate headphone and microphone usage.

Multiple Processors Availability Due to the Thermal Solution:

This concept ties into multi-user mode of having the system be capable of using either one processor or up to two processors (CPUs) that are designed into the actual physical system. This provides unlimited processing speed per user. And is possible due to the combination of the additional case area and the ensuing thermal solution as is described below. Under this configuration, one user could be using one processor and another user using the other processor offering the exact no compromise computing power of two stand-alone PCs. This has more advantages instead of having two users sharing one processor.

Dual Processor Mobile Workstation:

The dual processors can also be linked together so that the unit becomes the first dual-processing mobile workstation. This is unheard of in the mobile world.

Mechanical Design Simulates a Virtual Display:

As mentioned, the dual display system side by side is significant and unique unto itself. But the ability to expand the usable screen area to up to 4 displays that are arranged on either side of the machine that allows for an amazing resolution of 1,024×3152 is further enhanced by the mechanical design of the system in that it provides for a very minimal gap between the individual panels. This is far superior to the current usability that users must endure of standard self-contained monitors combined under traditional multi-screen applications. This is because the frame area around independent desktop monitors is much larger than the 3-4 mm gap between the Flip-Pad displays. In theory, the design could be expanded up to multiple (9 or more) additional displays if one chooses. Once again, the key is the minimal gap distance between the displays as compared to standard desktop displays. The Flip-Pad is the only way to get a true multi-monitor solution that more closely resembles one large contiguous viewing area. As a result of the unique applications that now become available like never before, the user experience expands immensely and productivity goes way up.

Flip-Screen™ Accessory:

An accessory unit will have a proprietary design for an interlocking hinged clamshell design that conveniently houses two additional LCD screen panels for use with the system. The case will hinge in the center like a book, and upon opening, the dual portrait displays are presented to the user for viewing. The unit can be connected to the base unit intact, or the unit can be separated at the hinged halves for presentation on the desktop surface. When separated, the individual displays are then placed on either side of the main Flip-Pad units existing displays. The cases will be stylized to match the external housing of the base unit and will also have fold down multi-adjustable hinged feet for leveling and equalizing with the screens mounted on the base unit.

Flip-Book™ Downloadable E-Book:
The dual clamshell designed auxiliary screen system described above also may contain one additional proprietary feature, and that the additional electronic storage and circuitry built into the screen cases, so that text may be downloaded into the screens and edited via touch sensitive screens and a form of stylus. This is extremely useful alone or as part of the entire system as a lightweight full-size electronic dual screen textbook (or NextBook™ or Flex-Book™). The ability to download user created documents or notes created via the keyboard or with the stylus and then to carry only the screen tablets provides a very lightweight enhancement to the Flip-Pad system. The text editing done with the assistance of the touch sensitive screens, the data is then stored in a form of electronic onboard storage and then is available for electronic download to the base unit via either the infrared capability or through a cable connection or both.

Custom Portrait Configured LCD Panels:

The fact that no company has designed a full-time portrait LCD is something that is of great value to Xentex. The design is for a reorientation of the standard row and column drivers of regular landscape LCD monitors into a portrait mode orientation is new and unique and of Xentex design. (Details to follow).

Four Users on One PC:

The Xentex design has the ability to extend the two dual displays in the system to have additionally 2 additional remote screens, which could reside anywhere in relation to the system. These two additional displays when attached to the system can be viewed as either mirror mode (duplicate) of one of the displays in the attached system, or could have all four displays in the system as mirror mode. In addition, all four total screens can each be separate as unique individual screens running off the system. The unique point about the external screens is they can be in landscape or in portrait mode.

This also allows up to four users to log on and have their own viewing sources per user. Using the units additional base unit case area to add additional USB (Universal Serial Bus) ports, the ability to add the necessary keyboards and pointing devices, including the folding keyboard expansion devices mentioned in the first application, to provide the input means necessary.

### Screen Rotation/s in Detail

Tablet Mode—Rotation of Only 180 Degrees:

The screen may then be folded back upon the case half and then when the base of the unit is then fully closed in order to provide an electronic tablet surface (utilizing current touch-screen LCD technology), upon which the user may write notes via a digital ink software program by using the onboard stylus pen, to control the machine when it is in the following landscape/DVD mode. Also, this limited range of rotation (180-degrees) assists in the hinges ability to support the weight of the screen so that it does not slip down when the unit is elevated into DVD mode.

Landscape/DVD Mode™:

The unit when folded back upon itself, the user may then release the base sections from the locked position and position the units screen at a comfortable viewing angle using the base hinge and the included stiffening clutch, to position the unit so that it is serving to display the one screen in the traditional landscape mode. The unit will feature a “hot button” which is a single function dedicated button located on the device, to toggle the image from its native portrait view to the required landscape or DVD viewing mode.

This orientation is of additional advantage in viewing areas that are small in work area such as in an airplane seatback tray arrangement. For reference, due to the shape of a traditional portable computer where the screen lifts up from the base unit, the user often needs to slant the screen far past the 90-degree full vertical position for ease of viewing. This is in direct conflict with the seatback mounted airline tray, since the seatback also reclines towards the screen that is flipped backwards. Often the screen and the seatback collide and the screen either breaks, or the user needs to move their machine. This is very cumbersome and difficult.

Dual 180 and/or 360-Degree Rotation of Both Displays:

The unit can be configured to provide for both displays to rotate 180-degrees and then be folded back upon itself to provide for a easy to read and write upon digital tablet and also as a full-sized dual screen digital e-book or E-Magazine™ to allow users to download current books and periodicals and read it onscreen full sized.

Dual Displays in Landscape Mode:

The unit can then be unclasped at the base and have both the left and right display's onscreen images toggled to landscape. Utilizing the rubber strip that wraps around the unit as feet to stop the “tented” unit from sliding on the desk, the unit can then function as a dual-display in landscape mode for head-to-head gaming, kiosk or other such landscape oriented applications.

The unit will also function as a dedicated single function DVD or visual CD or CD/DVD based single or multiple (up to four) screen game display platform as is described below.

DVD/Gaming Mode:

The unit when functioning in the dedicated DVD/Game playing mode, can function as a stand-alone device that plays: either DVD movies, video games or music CDs without the need to run under Microsoft Windows or other such Operating System (O/S). This is useful because the unit need not be consuming precious battery resources to run the operating system and can dedicate all of the available precious battery-power resources to running the media of choice. This is achieved by using a dedicated circuit board that imitates the DVD/CD/video gaming hardware circuitry and is booted into the proper mode based on one of the following occurrences: 1) if the unit recognizes the unit is folded into the single or dual landscape mode via a proprietary switch, 2) if the onboard gaming device-bay drive is loaded, or the user selects the proper boot-mode from the proprietary BIOS selection.

Dual DVD Mode:

Thanks to the dual screen nature and dual expansion bay (more info to follow) ability of the unit, two users can view two separate DVD movies or media per screen using two accessory DVD drives. This ability to interact as described below in the gaming device-bay section, and also to be entertained by movies two at a time is truly unprecedented in the world of computing and most certainly in the realm of portable computers. This mode is available under either dual-portrait viewing (side by side), or under dual-landscape (both display rotated 180-degrees and then folded back down upon the base of the unit).

3-D Viewing:

The unit can reproduce three-dimensional images for the user like no electronic product ever invented. What is known, is that to effectively reproduce a 3-D image, the image must be photographed from slightly different angles (usually in single colors) and almost always as a still image. The user then dons a pair of special glasses that serve to combine the colors and the image in order to fool the eyes and the mind into seeing an object in the third dimension. This technique was pioneered in the 1800's with a device called a stereoscope. The stereoscope took two separate photographs of the same scene or object and mounted them side-by-side on a rack. When the user held up a special set of lenses to their eyes, the combination of the differing angles and shadows of the photo images and the reorienting nature of the lenses, the image appears to be in 3-D.

The unique side-by-side nature of the Flip-Pad allows the user to easily enjoy 3-D viewing. Xentex is creating a proprietary system to enable this that consists of 1). Unique 3-D software and/or a software compiler that converts images (still or in full-motion video) into the proper split angled image necessary to recreate the 3-D effect, 2). Special lightweight and stylish viewing glasses necessary to complete the effect.

This system will be a lightweight and comfortable way to view 3-D on a PC like never before. This will further enhance the gaming environment as is described below.

Gaming Device-Bay:

The Xentex Flip-Pad has the ability to house the necessary gaming hardware to recreate the video console game experience in a mobile platform. This hardware can be housed either in the second case half or as a device that slides into either one of the dual 5¼″ expansion bays in the case. The advantages of this approach are outlined below. The current crop of dedicated gaming consoles such as CD based platforms made by Sony Corp. as the Playstation, and Sega Corp. as the Dreamcast system, or Nintendo Corp, as a cartridge based system known as the N64, all suffer five known drawbacks as is described below:

### The Current Problems

1) The units are not considered to be portable and self-contained in their entirety (no screens to view the action)
2) The units currently only support one single monitor as the viewing source shared among the on-screen participants, meaning that the image is partitioned off in the software, equally per user on a single screen. This causes much on-screen confusion to the players.
3) The primary viewing sources (standard TV sets) currently cannot support the high enough resolutions that these hi-powered games can display, thus the image on-screen does not live up to the programming efforts and capability of the gaming platforms hardware.

4) Currently, the only way to add more players that can use their own private screen, is to link separate gaming systems together via cables. The Flip-Pad unit solves these problems by design.
5) Most platforms allow for up to 4 players to interact onscreen in many popular games, which only compounds the screen division problem, whereas the single physical screen is divided in the software to provide for four smaller individual windows. This can get very confusing.
6) The existing units require ever-larger amounts of information to be part of the gaming experience. For example, the player has maps, data files, inventories of collected items, etc. to consider in the gaming experience. This means that the interaction of the game is interrupted every time the user exits the action sequence of the game to access this information. Thus rendering a sequence unrealistic in that the opponent is forced to wait until the screen action is resumed.
7) The heat generated by the processors and hardware necessary to run the current crop of high-speed video game consoles, is overwhelming to, and thus currently precludes the design of a portable gaming system

### The Flip-Pad Solutions

1) Due to its Unique Quad-Fold™ design, the unit is considered highly portable, and it features two adjustable displays.
2) Utilizing the dual displays whether rotated or not, or in the native portrait or in the folded dual landscape incarnation, (though rotation is favored for secretive head-to-head applications), electronic versions of classic games like Scrabble, Poker, Battleship, Racing games, or any adventure that requires secrecy per user become all the more enjoyable when each user is treated to their own display for ease and enjoyment of interaction. Furthermore, in two-player cooperation games, if one user tries to go ahead of their on-screen partner, the faster user is forced to wait, simply because one display cannot display two individually rendered environments individually for each user. The unique gaming environment provide by the two displays remedies this for the first time in a self-contained gaming (portable) system,
3) The unit features the highest resolution LCD screen known to the PC market and as such is the first portable self-contained gaming entertainment system that can display the high-resolution imagery made possible by today and tomorrows future technologies.
4) The Flip-Pad unit can allow for two-players or computer users to interact simultaneously or in entirely separate environments based on their needs and is not restricted by the current crop of technology. In other words, the unit itself contains the processing and video power to render to individual on-screen images and then the dual displays can function as individual viewing sources without the need for two or more separate video input sources (in the case of two separate linked units, and two separate displays). The unit can also seamlessly support up to two more portrait or landscape displays, as is described below:
5) Thanks to the unique nature of the Flip-Pads Quad-View™, four monitor support solution, each of the four individual gamers or computer users can play via their own private monitor.
6) Due to the flexibility that the multiple monitor solution that the Flip-Pad Quad-Fold design permits, the User can plug the unit into a larger viewing area, Such as a big-screen TV set and use it to view the onscreen action continuously, while the primary displays of the unit function as the “Heads-up” information displays simultaneously. This is unprecedented in gaming and any also is useful in presentations and such as is described below:
7) The Thermal Solution as described in the Thermal Solution Provides Multiple Upgrades and Layouts Section, page 31, the units inherent thermal design works with the laws of thermal dynamics to dissipate the heat far in a manner superior and unique by comparison to the current design of portable electronics. This allows for a solution set that provides the basis for the first truly portable gaming system that sacrifices nothing in terms of performance in comparison to the stationary models.

Detachable Displays:

In a separate incarnation of the design, gone or both of the unit's displays can also be are detachable for a multitude of reasons. It has already been mentioned, that the rotation of one of the displays is most useful for interaction and presentation capabilities, though for presenting to large groups in an auditorium for example, the field of viewing is somewhat limited based on the screen size of one display. Though the Flip-Pad is far superior to existing portable presentations on a laptop, sometimes a presenter needs to project a very large image for group to easily view from a distance such as in an auditorium. Currently there are only a few solutions for presenting computer-generated images to others. 1) A plug-in projector, which is a very expensive (typically $3,000-$5,000 or more), 2) or a plug-in LCD panel that is then laid upon an inexpensive standard lighted overhead projector, 3) or a custom laptop that allows the back panel of the otherwise traditional notebook screen to be removed, and then the entire unit is laid with the uncovered rear of the otherwise traditional display to be supported on the overhead projector (as describe in example 2 above), and the laptop units built-in LCD functions as the LCD panel for projection. In any of these examples, they are very expensive and cumbersome to implement when compared to the elegant Human Solutions by Design™ that the Flip-Pad system provides.

In definition, the unit can detach either the left or right display from the base unit via a proprietary hinge/connector apparatus. The signal is then sent to the detached screen via a connector-equipped custom cable, or via the infrared signals generated by one or both of the two onboard infrared (I/R) windows on the base unit. It is at this point, that the user then removes the back panel housing (including the reflective surface that serves to project the image forward) of the screen in question. Thus providing the equivalent of an onboard LCD panel for projection purposes, that can then be laid upon the overhead projector for a simple solution to the presenting problem. The advantage to the presenter is that they still have one of the active screens docked to the main unit for their speaker's notes or other information that they wish to present. As is described in the Gaming Device Bay Section, # 6, above, the user benefits even when a projector or other video source is plugged into the existing unit and used simultaneously in conjunction with the primary displays of the unit. This allows for a presenter to have the presentation on a larger screen behind them in traditional presentation style, thus properly addressing the audience and having the benefit of the dual displays with which the user can have one screen reserved for the speaking notes and the other to show the slide being presented behind them for ease of reference.

Detachable Displays-2/Dual Notepads

The detachable display/s are also useful when the user wants to use one or both of the displays as easy to manage electronic tablets. In this scenario, the user/s can each detach a lightweight screen and connect the cables or use the built-in infrared capabilities to send the signals and use the tablets freely to enter text and take notes, away from the base unit. In this case, the unit is beginning to serve as a storable file server to the two independent writing tablets.

For example, for convenience or when user space is limited, such as in an airplane, the unit could have either one or both of the displays detached from the base unit, and then have the cables connected between the screen/s and the unit, while the base unit is stored in a travel bag, under the seat of the aircraft. The signals could also be relayed back and forth between the screen/s and the base unit, via the infrared or otherwise wireless signal. In this way, one or two users (traveling companions) can either work or play together via the tablet user configuration.

The unit will also feature detachable screen supports that allow the user to attach the clamps of the screen support to any side of the screen for either landscape or portrait viewing on a flat surface. This is so that the user need not hold the screen to view it. Once it is clamped firmly to the screen, the unit's flip-down, adjustable foot supports the screen on a flat surface. The foot is hinged to flip down, and also offers a range of motion to angle the screen to a comfortable angle.

Custom Reel Monitor Cables

The Flip-Pad requires that the signals be sent to the detached screens in order to recreate the imagery and handle any input/output signals. The unit will allow for the transmission of the signal via a wireless medium such as infrared (I/R). It will also allow the unit to send the video signals via a connected cable that runs from the base unit connection to the screen-mounted connection.

To facilitate the portability and convenience of this fact, the design calls for a custom (proprietary) design of cable that has a quick-coupling on either end to facilitate ease of connection, and a housing with a reel mechanism inside that allows the cables to be extended to the total length for use and then retracted back into the housing for stowage and ease of travel.

Proprietary Dual Screen Usage Applications:

There are currently many uses for dual screen applications, graphic design, video editing, computer aided design and manufacturing, CAD/CAM, software and website programming, financial trading, gaming, etc. Though these are well known and established areas of use, Xentex has designed several proprietary applications for use with the system as described below and also more in detail in a separate patent application:

### Internet Software Applications

The Internet has become very pervasive and has significantly exaggerated the amount of time that people spend at their computers. In fact the Internet has revolutionized the way we work, play, and learn. True as this may be, the Internet browsing experience is far from perfect. Thanks to the multi-screen nature of the Flip-Pad system, many new and useful applications can be designed to enhance the experience.

Backward/Forward Button Screen Management Plug-In™:

The first is the Backward/Forward Button Screen Management Application. Research shows that the “back and forward” buttons are the most frequently used buttons in browsing. This is so that when you want or need to view the previous web pages, you tap either the back or forward button and the browser window reproduces the former page/s. This can be very frustrating on a single screen landscape computer, since the page you left is likely still of interest to you, yet you simply cannot view two full pages simultaneously.

This is no longer the case, with the proprietary Xentex software plug-in, the user can set the browser so that upon pressing the back or forward button, the browser will reproduce the current page being shown on the primary display to the opposite display, then producing the page new page on the primary display. This will greatly enhance the browsing experience and increase the level of information retention by the user.

Comparative Windows and Shopping:

Shopping and auction sites via the Internet have increased exponentially in the years since 1996 when the net went primetime. The ability to view images of products and read their individual specifications while comparing prices amongst vendors virtually at will, has forever altered the way we purchase items and “window” shop. Yet one must still contrast and compare at least two competing products or prices, and levels of service, etc. to be sure of getting the best value for their money. The most effective way of doing this is a side-by-side comparison. This Xentex application will efficiently marry search engine technology with multi-screen technology to produce a revolutionary way to shop smartly, with far better informed and savvy customers as the result.

The software will allow for searches in the comparative mode that will produce mirrored browsing windows on each screen. What is currently known is that the user can simply bring up separate browser windows and toggle between windows to compare or on a desktop system using multiple monitors one could simply leave the windows up and compare. What is unique to the Xentex Window Shopper™ custom application is that it is one large browser window that is reproduced on the individual screens as separate Window Panes™ that have linked search engine capability. Simply put, the user can input a specific product or a category and then refine the search by setting price, shipping, service, size, weight, etc. as the search parameters, and easily compare products and services side-by-side, instantly. The software also has the ability to narrow the search once satisfied and to easily seek out features on the presented pages that are individually entered into the refined search engine

Training Module:

Thanks to the units dual screen nature, the machine can function as a mobile training platform.

The problem with software today, is that by the time you get familiar with the program, the software developers have come out with the next generation of software, thus the learning curve usually out accelerates the average user. Additionally, the software is very complex, and the included user manuals are usually difficult to understand, so the user usually buys an aftermarket user manual such as the IDG Books “ . . . For Dummies,” series. This leaves the user with the dilemma of always needing to purchase expensive manuals that quickly become obsolete, and also they obviously cannot carry all of them with for reference when traveling. This often leaves the user at a distinct disadvantage. The Flip-Pad system solves this by using the unique capabilities of the machines dual screens to provide for a mobile training system. By using the second screen to mirror the software program that is loaded full-screen on the primary monitor, the user can then load the training software that is a mirror image of the program on the other screen. By doing this, the user can see a full-screen reproduction of the program that they are trying to learn, and the software then shows the user what to do by moving the cursor and simulating the acts necessary to learn the program. This will allow users to see it on the one screen, and follow along on the other. Furthermore, the user can then efficiently download updated versions of the manuals directly into the machine that corresponds with new versions of the software being learned.

### Case Design

The Flip-Pad's unique case design offers the ability to solve many of the engineering hurdles that face designers of traditional clamshell portable computers. This is detailed individually as follows:

Ergonomics:

Ergonomic considerations are fast becoming a topic of concern for the computing world. The reason for this is that Repetitive strain injuries are sharply on the increase. This is due to the extended periods of time people spend interacting with the PC and its less than ergonomically correct design. This is further aggravated by the confined and cramped design of portable computers. The current laptop design forces the user into an uncomfortable array of posturing as is described below:
1) The keyboards are too small,
2) The keys are reduced in size from the desktop standard,
3) The keyboard is to close to both the screen and the user,
4) The keyboard has no room for the extended function keys (numeric keypad, etc.) as found on larger desktop keyboards,
5) The screen is mounted to low for comfortable viewing without craning the neck,
6) The keyboards are either to high or to low, based on the features inside these small cramped boxes.

The unique design of the Flip-Pad Quad-Fold case provides for the first full-sized computing environment that when unfolded, and is no wider than acceptable travel size of the competing products within the size related category it is addressing, when folded closed. This provides for the first collapsible desktop computer that provides all of the advantages of the following:

1). The unit provides for the first dual screen in portrait mode that mounts the screens at the proper eye-level height for comfortable viewing.

2). The unit mounts all of the necessary expansion bays and connections conveniently inside the base unit that sits on the desk. This is a distinct advantage for convenience to the user, because the user need not reach underneath and then to the back of the unit or alongside the desk for the traditional desktop case.

3). The unit also does not require the use of a docking station or port replicator, like portables do.

4). The unit occupies only slightly more space on the users desk than a does a standard ergonomic keyboard. This is of great use to the average worker who already has very little space on their desk to work from.

5) The keyboard of the unit is more orderly and easier to operate than standard keyboards since the additional function keys are reorganized symmetrically on either side of the regular alphanumeric key sections. This makes it a more balanced and easier to operate keyboard.

6). The keyboard is positioned in a very natural and ergonomically correct and comfortable angle due to the positively deployed feet that are built into the rear of the case upon opening.

7). The unit also features additional case area for additional ports such as USB and 1394 “firewire” and others. In fact, the unit can function as an integral USB hub as a result of the case area.

For example, in the larger version, the design provides all of the necessary cavity space to accommodate the components of a full-sized desktop workstation including a 23″+LCD display, in a package that then folds for travel to be no larger than a standard large portable laptop.

As a result, the ergonomics are far superior to that of a desktop or a notebook or other comparative travel size upon opening and using the Flip-Pad. The advantages go far beyond the spaciousness of the keyboard, since the depth of the case provides a very comfortable depth from the front leading edge of the unit to the screens, with plenty of room for a nice deep palm test. It also offers the room to install a full-sized alphanumeric keyboard with the desktop sized auxiliary keypad. As a result of the portrait-mounted displays, the top of the LCD screens are at the prescribed eye level height as is dictated by the design parameters set by ergonomic experts today. No other portable PC offers this level of ergonomic design consideration.

Thermal Solution Provides Multiple Component Upgrades and Layouts:

The design of the Flip-Pad system is intrinsically advanced in terms of thermal management. One of the most difficult items to manage in portable computing designs is how to dissipate excess heat generated by the tightly packed high performance components within the small plastic case. As the performance of the latest chips is increased so to is the heat that they produce. In fact, there is a direct correlation between performance and heat. The faster the chip the hotter it gets. Furthermore, the faster and hotter the chip, the more battery-power it consumes.

The unique mechanical design of the physical box of the Quad-Fold Flip-Pad allows for several amazing solutions to the thermal issues suffered by standard portable designs. Since, the physical box is divided into two sides and hinged together, in terms of the major components in the design the left side and the right side can each accommodate an expansion bay, PC boards, processor boards, keyboard, and other component modules. What this allows in terms of thermal design is impressive, since heat sources can be identified and located apart from one another inside the case halves, thus minimizing the heat multiplying effect. This is further assisted by the ability to house a large fan in the folding sections of the case without causing the base of the case to become overly thick and thus less portable and harder to type on, since it raises the height of the keyboard to unacceptable levels. In other words, the left-side case of the hinged base unit houses the processor and the corresponding oversized cooling fan. The fan can be made significantly larger since it can “cut” into the area cutout on the right side. This adds to the thermal solution exponentially.

Beyond the basic layout, the thermal solution allows for several other layouts that are possible as a result of the unique physical design of the box. They are as follows:

1. In the first design (as briefly described above) the system must pass all the thermal conditions of using a high end CPU such as Intel's Pentium line or Motorola's PowerPC line. In this design the digital motherboard (main PC board) and the processor fit on the left side of the design in there own enclosed space and the power supply and hard disk drive fit on the right hand side of design. In this design the CPU and digital motherboard have been isolated from all the other electronics that currently reside on the right side. This design solution allows the component heat to be distributed evenly throughout the system and gives a clear path for the CPUs fan to evacuate the generated heat out of the system bay. This incarnation of the design allows for the ability to fit a high end CPU in the design whereas other traditional notebooks do not have as much space.

2). A second design is to have a dual processor (CPU) machine, similar to stationary desktop workstations and is the first of its kind in the portable realm. This unprecedented design has a CPU either the same case side, or one on each side of the machine, with the necessary motherboard. In either case, a traditional portable computer cannot do this because it one has one physical cavity such as the ‘left’ side and that must already deal with ever increasing amounts of heat in a small enough bow to be considered portable.

The Flip-Pad is the first known portable computer design that is capable of being a true dual processor system. For reference, dual processors are usually required for high-end computing, and are typically only available in large cumbersome non-portable workstations. The dual processor design could be implemented for the three different modes of usage.
1). The first being that the dual processors are used for a single end user. This gives the end user extra performance and power when using the correct software applications. Much like the dual displays when combined doubles the amount of usable screen real estate.
2). In a second application (like the two-users on one machine) now the two users could use the same system (one machine) and each have their own processor and display. This provides for
3). In the third mode, the second processor serves either of the two functions mentioned above, but can also lay dormant to serve as a backup CPU for redundancy and backup precautions in the field. The added safety net of redundancy in field applications where a processor or screen failure cannot be tolerated, as is described below.

Dual Processor for Multi-Boot System:

As is first described on page 5 of this application, the User is able to load multiple operating systems on the unit and use them simultaneously. For example, Windows and LINUX can be run at the same time. In the full realization of the product, the system features a fully integrated system custom designed native ( ) and ensuing software applications. In fact, the expansion (second) side of the case will house a second processor (possibly a RISC processor) as mentioned. This will allow the unit to contain the;

this will allow users immediate access to the Internet without having to wait for the PC to boot-up. In other words, the one side is a PC and the other side is a dedicated Net terminal running off of either a standard modem connection, or a DSL line. For example, the user is able to quickly get online while the other chip is booting the WINTEL system in the background. Thus increasing user productivity. This creates a solution that is not currently available.

The self contained nature of the unit will allow for a future version to run completely off of its own software and use any one of the current crop of computing chips and architectures that are available.

Redundancy of Components and Fail Safes for Field Applications:

In the third setup, the Flip-Pad design is a system that provides a dual backup component for almost every key component required to be a functioning computer. These are the screens, the motherboard, CPU, hard-drive, battery, etc. This is so that the device can still operate if the screen or main motherboard, etc, are damaged. The military, space exploration, and fieldwork applications, whether by land or sea, are obvious. Since these endeavors require redundancy and fail-safes such as these in all field applicable technology. In support of the usefulness and novelty of the units design, as it relates to the above mentioned activities, field work also requires the user to have ready access to mission critical information such as maps, targets, trajectories, orders and communications, etc. This is only now truly possible via the unique and novel designs of the various folding architectures presented herein.

Dual Processor Anti-Crash Backup System:

The system also provides the advantage of using the backup systems that are onboard, to copy the work that is being created on the primary system board and CPU, and backs up the work, so that if the main system experiences a system failure or “crash”, it becomes transparent to the user, and crashes become a thing of the past. The system will self-sustain itself, until the unit is powered down.

### Case Design Summary

All of the above designs are not only due to the unique industrial design but also to the ability of the design to handle thermal issues. There is no other truly portable computer of this size that can handle as much heat as the design of the system. Note this is transferable to even the smaller physical designs which Xentex has designed compared to other smaller size portable computers or PDAs (Personal Digital Assistants).

Scalable Case Design Provide Incarnations & Solutions to all Known Segments (Vector™ & Stealth™):

As mentioned, the unit folds down, to provide the ultimate in travel. It then unfolds to become a much larger and accommodating workspace and case area for peripheral docking. This solution becomes all the more relevant as you scale down in screen and case size to address the well known concerns of the ultra-portable market segments. This design could have the screens mounted in either the traditional landscape or in portrait.

The sub-notebook and handheld markets a very specific in terms of what is considered portable per segment. For example, a handheld must fit easily in a coat pocket, which is great for on-the-go computing, but the reduced size for travel makes effective typing and onscreen viewing very difficult. For example, in order to check email or a website on the current handheld computers the user must not only scroll top-to-bottom, but side-to-side just to view a full page of information. The users identified in these existing segments require greater portability in their computing devices. Since the technology is available today to shrink the necessary components to fit within cases that are less than one inch thick, the problem quickly becomes one of usability and productivity. This is because the current designs are merely the traditional clamshell design scaled-down. As a result, all of the known problems become greatly exaggerated for the user. In fact the one benefit of portability when taken to extremes quickly diminishes the productivity advantages that ultra-mobile computers present.

Simply put, the user needs a really small device to travel easily on frequent trips. Yet the reduction of the case requires smaller screens, keyboards, and typically the removal of all of the major components that complete the computing experience, such as CD ROM/DVD Drives, floppy drives, and even speakers, etc. In fact, when these ultra-portables are equipped with all of the external auxiliary drives and accessories that are truly required for effective and complete computing, the unit is anything but portable, with cables and components all over the desk area.

This again only exaggerates as the design is scaled down one more time to address the pocket-sized market for handheld computing. Also note, that the ability to put faster processors drops off significantly, the minute that the units scale below a standard full-sized notebook package. This limits the productivity of the user even further.

The Flip-Pad Quad-Fold Architecture becomes all the more relevant, the minute that smaller more portable travel sizes are required. The units expandable case design allows for the unit to still be designed to be very thin, but due to the area and thermal solutions described above, the units can feature and retain most or all of the expansion bay capacity required of a proper computing environment.

With regards to the ability to rotate the screens and present and use as a tablet, the frequent business traveler or “road warrior” will find the added advantage of being able to use the smaller units as a very portable tablet. In fact, the smallest unit known as the Stealth, is the first handheld that simultaneously offers the benefits of a palm-based mini tablet similar to the Palm Pilot™ series, with all of the advantages of a more traditional keyboard enabled system. This is unprecedented in the handheld market.

### Stealth Added Functionality

CPU: Due to the expandable case size, the Stealth can conceal in a pocket for travel and yet still provide the engineers ample room to actually install a mobile Pentium chip in a handheld sized box. This is the first solution to this problem.
Communications (Flip-Phone): The unit can have a full function cellular or satellite connectivity circuitry installed inside the second case half and allows the user to handle data and connectivity anywhere in the world. The unit will feature a dial pad underneath on what would normally be the underside of the unit. Additionally, the unit will feature built-in telephone ear and mouthpieces in order to function as a full-fledged cellular/satellite phone, that angles like traditional flip-phones for comfort.

Internet Phone Capabilities:

This following hardware and software description is compatible with all of the size variations of the Flip-Pad system; in fact, it will be eventually built into dedicated cellular-like portable phones that use the dedicated Xentex dial-up system.

Xentex Has designed a proprietary chipset and software package that will allow users of the Flip-Pad, to communicate with other users by making toll-free calls via the Internet. Use of the Internet to place toll-free telephone calls is not new, it has typically required PC's that are both using the same software. The concept of providing dedicated hardware and software in either a module inside the Flip-Pad devices or in separate telephones that are designed to operate on the proprietary Xentex network, is entirely new.

Truly Portable Gaming: Current handheld game devices and game enabled wireless phones and accessories, suffer several limitations to enjoyable gaming as is described below:

Performance: The portable gaming platforms such as the Nintendo Gameboy do not contain sufficient space to accommodate fast processors required to run full motion 3-D enabled gaming. The Flip-Pad Stealth has ample case room in a portable form factor to accommodate Pentium-class processors.

Screen Size and Resolution: There are two limitations here, size and color depth. The Flip-Pad Stealth can offer a truly life-like reproduction of size and color as compared to most other screens on portable hand-held video game devices.

Two Players: Since the standard game devices only feature one screen, the ability to play with a companion is severely limited and requires the addition of a linked second compatible game device. The Flip-Pad design for rotating screens allows a second control pad to be plugged into the unit to allow for two-player interaction.

Added value: The Flip-Pad Stealth offers the added value of a completely portable Pentium-class computing device that also offers the value of a two-player gaming device.

Limited and proprietary Software requirements: The portable game devices available today only work with the proprietary software produced and licensed by the game device manufacturer, as is the case with the Nintendo GameBoy. The ability of the user to benefit from the vast library of PC games and to be able to then download them and or engage in Internet gaming is currently not possible. The Flip-Pad Stealth as a fully capable-Pentium-based mobile computer allows this for the first time.

Docking Capability The Stealth also has the ability to easily dock with the larger Flip-Pad units for easy file downloads. Currently one typically needs either a dedicated cable or a hardware-docking cradle to interface their handheld with their larger primary computing device, be it desktop or laptop. If either the dedicated cable or cradle is unavailable the download typically cannot occur. The Stealth remedies this dilemma in several ways:
1. The unit is designed to dock in the semi-open state (the base is unfolded, but the screens are still closed) with either one of the larger units 5¼″ device bays. The Stealth has dedicated ports on either side or just one side-edge to accommodate the data connection with the larger Flip-Pad unit. Upon removing the device occupying the bay, the user then lifts the remaining individual screen on the Stealth and raises it into a viewable position. This allows the user to see the files to be downloaded from the Stealth onto the larger unit. There is also dedicated proprietary software that allows the docked Stealth to be recognized by the system and enable the file transfer to occur.
2. The unit also features infrared (I/R) window/s that allow for wireless transmission or reception of data.

### Full-Sized Keyboard Summary

Full-Sized Keyboard & Numeric Keypad:

Keyboards on computers are a major issue these days, the dramatic increase in the rise of Repetitive Strain Injuries or (RSI), have reached epidemic proportions (800% increase over the last decade). The scary part of RSI is that it is a debilitating affliction brought on by uncomfortable positioning of the body as it is forced to repeat the same repetitive motion for extended periods of time, and can affect anyone at any time. This is further aggravated in the world of computing two-fold. First we are spending ever-larger amounts of time seated before our PCs (desktop or laptop), and secondly the laptop design is too small and confined, with keyboards that are either too high or too low, and keys that are too small and cramped. Not to mention the fact that the keyboard is pushed unnaturally right up to the LCD screen. This is a highly uncomfortable and straining environment with which to work.

The Xentex Flip-Pad solves all of this by design and the interlocking feet and port doors elevate the unit to the proper keyboard height. Plus the additional case area permitted by the folding base, allows the unit when open to be much thinner than most full features notebooks, thus providing a substantially more comfortable and safe computing environment.

Additional Unique Keyboard Features:

The units split keyboards required by the split-folding design of the base unit provide for several unique enhancements thereto:

Removable-Keyboard Sections for use in the Various Folded Articulations of the Case: The unit's individual dual alphanumeric key-slabs are removable like the standard keyboards on other portable computers. Typically the keyboards are removable for access to the components underneath. The Flip-Pad utilizes the removal for these reasons also, but also for something entirely different. When the unit is folded into the DVD mode for convenient landscape viewing in tight spaces, such as on an airline dinner tray, it lacks the ability to have access to the keyboard. The unit's keyboards are detachable and fully operational via either wireless or cable connections. The units can be detached from the housing via a release button on the base of the primary unit, and then used as if they were docked with the unit, to provide for a keyboard when the device is in any one of the articulated (alternative folded) modes.

Replaceable Key-Sections: The keyboard area of the unit is over-sized and symmetrical as compared to standard 104+ keyboards. This allows the unit more area to add accessory key devices to supplement the unit's capabilities. In detail, the keyboards of the unit can be removed and replaced with custom unique configurations of keys and or other buttons or switches, such as a video-editing terminal complete with all of the necessary buttons and fade and wipe slider bars. The video-editing slabs will also feature a reduced alphanumeric key field for use in titling work on the editing of the video feeds.

Height Adjustable Angled Key slabs to Provide Ergonomic Benefits:

As mentioned, Repetitive Strain Injuries are increasing dramatically with the increase in proliferation of the laptop computer. Over the last ten years, RSI injuries have increased over 700%. Keyboard's, especially the less than optimally sized reduced keyboards of the portable PCs, are a major culprit. By ergonomic experts opinion, the standard 104+ keyboard layout is less than optimal. In respect of this fact, a new key layout has been designed. Not a major departure from the regular key arrangement, the engineers have split the key sections in half and then angled the keys upward towards the central split and sloping gently downwards to the outside edges.

Dual 5¼″ Device Bay Expansion:

The units' folding base section provides ample room for all of the necessary components required for full-fledged computing. The fact that the unit is the first portable to be able to accommodate dual 5¼″ expansion bays that can house any number of accessories such as a CD ROM or DVD drive, a Zip Drive, a Floppy or LS-120 drive, etc. The beauty of this design is that it not only can efficiently have two such expansion bays available, they need not be used for a battery like on all other portable computers, since the unit houses a third dedicated battery bay as is described below.

Battery Time:

The unit has room to accommodate a third system bay that houses an oversized rechargeable battery pack. This battery case being larger shall provide additional battery time without the removal or installation of a new fresh battery. Furthermore, referencing the dual 5¼ expansion bays mentioned above, the user can empty the dual bays of their devices and install one oversized bay-sized battery per side, for an unprecedented 3 oversized onboard batteries powering the system. This brings about two additional enhancements:
1) The unit will provide unprecedented cordless computing time in the area of approximately 12-14 hours.
2) The ability to run the new fast Intel processors (600+MHz) full speed. The new processors are very fast and consume a lot of power and generate a lot of heat. This being the case Intel has designed the chips power management to allow for maximal processing power only while plugged into a wall outlet. The power of these chips is at about 20 watts and cuts the available battery time in half. Since one or two standard sized portable batteries would drain within an hour or two at most this is unacceptable. The Xentex system of three oversized batteries allows the chips to run full-speed for approximately 6-8 hours, or a full workday.

The system has longer battery due to the fact can have up to three batteries in the system at one time. One battery pack goes into the custom battery bay in the system and two other battery packs can go into the two standard expansion bays in the system. This gives a maximum of 3 battery packs inside an entirely single system if the end user decides to do this.

The unique item about three batteries is that the Flip-Pad is the first portable computer, which has this capability. Every portable computer on the market today has only a maximum of 2 battery packs. There are several unique design features to having 3 battery bays. In this design Xentex needed to design unique algorithms for charging and discharging three batteries. This is unique to the industry. It is a pretty well known common fact in the industry about dealing with 2 battery packs but three is a new and novel concept.

In addition to the new charging and discharging algorithms there is new User Interface software, which needs to be designed for 3 battery packs. This is unique to the PC industry.

The benefits of having 3 batteries onboard, is obviously longer usage time of the system. Battery life is very important to a mobile device and this design helps to allow a user to literally run the system all day on the 3 battery packs.

Expansion—Docking Station Case Half:

The fact that the unit doubles the available case area has profound impact on many areas, one of which is the ability to bring onboard many of the necessary peripherals that have always been external accessories. Specifically speaking:

1). A built-in portable fax/scanner/printer/copier module. Due to the size of the full-sized unit, the machine has the space to accommodate a standard 8.5″×11.0″ sheet of paper for printing. The unit will feature an ink-jet system of printing with both a manual and automatic document feeder and accessory tray. This system allows the ink-jet head to be swapped for a scanning head to bring a full-sized printer, facsimile machine, copier, and scanner to the portable world, not requiring an external device, or that compromises be made to the portability/features equation.

2). The unique design of the system also allows for future expansion for modules which are larger than the standard size expansion bays for typical portable computers which use industry standard sized CD-ROMS, Hard Drives, Floppies, Zip Drives, etc.

Due to the size capacity of the system devices such as cellular or satellite based type connectivity devices could be used in one of the left or right sides of the cavity. These devices could be much larger than the typical expansion bays.

An example of implementation would be using the right side of the system and putting a cellular phone into device without giving up the expansion bay. This would be a system with no compromises. Or a GPS (Global Positioning System) could be mounted internally providing for a well-designed sleek navigational and communication system.

Interlocking Feet and Port Door (Ease of Setup):

The unit takes advantage of the interlocking design of the case to provide for a unique enhancement that solves many of the remaining nagging complaints of computing. The machine features a proprietary design on the back of the unit that incorporates a system of interlocking feet and simultaneous port door covers. This is of great value to the user for the following reasons:
1. The Flip-Pad becomes the easiest full-featured PC in the world to setup. Since it is merely two steps to deploy the unit. 1) Unlock the base and set it on the work surface 2) lift and position the screens.
2. The design also offers a far more robust design for the feet and port doors as they are cast of the fixed case material. This means that there are no flimsy parts to break-off.
3. This also reduces the part count of the machine.

The fact that the feet are already deployed each time the machine is in use also offers several other advantages:

A). The units keyboard is positioned into an ergonomically comfortable and predictable angle for efficient and safe extended typing sessions.

B). It also is safer from liquid spills that may occur on the works surface, such as a cup of coffee.

Mechanical Thermal Solution:

As a result of the inter-locking design of the unit, two significant thermal management opportunities result:

1). The unit is elevated off of the work surface and this solves to other issues. The unit is further better able to handle the thermal loads of the components since the unit is not resting at any time during its intended usage, directly on the work surface, thus trapping heat unnecessarily underneath the machine.

2). The interlocking case design affords greater room for an oversized system ventilation and cooling fan to be part of the enclosure thus aiding in the cooling of the components, without over exaggerating the case thickness.

Superior Sound Quality:

The unit's design synergistically remedies the lack of acceptable acoustic performance of the traditional portable form factor. Since the Flip-Pad design offers greater case area, it can offer these solutions to the audio equation:
1. The wider deck area of the unit when opened provides greater distance between the speakers than traditional portables thus enhancing the stereo separation and sound clarity aspects of the acoustic solution.
2. The unit's greater case area and separate case chambers, allow both for greater sound cavities within which the sound can reverberate and build momentum.
3. The separate areas of the case (left and right) keep the individual speakers isolated from one another for far cleaner and truer audio reproduction.
4. Much like the fan/thermal solution mentioned above, the fact that the cases interlock allows for oversized speakers and the acoustic bulges to be placed underneath the machine that also serve as system stabilizing feet (as they are designed to encounter the work surface that the unit is resting upon). These oversized speaker cone areas provide far superior speaker sound reproduction and sound timber quality.

Expanded Input Output Ports Area:

The unit's expanded case area also allows for more ports to be built into the unit and hidden and protected behind the units interlocking port door, to provide for a more protective encasement of the easily damaged ports.

Total Cost of Ownership:

The overall all in one design of the machine and the completeness of the features provided therein, thereby eliminates the need for a costly docking station and peripherals as is common with portable computers today.

Furthermore, the unit possesses the ability to replace all of the following components, accessories, or separate products in one sleek unit:
1. A laptop
2. A desktop
3. Separate monitor
4. Auxiliary Keyboard & Mouse
5. Docking Station
6. Tablet Pen-Based Computer
7. Portable Dedicated DVD Player
8. Mobile Gaming Platform
9. Multi-User System
10. Translation Device
11. Printer
12. Satellite Link-up
13. Video editing terminal
   “Other Modifications”

There are variations on the theme as follows:

1). Shuttle™: Is a portable folding expansion device with full size keyboard interface. The unit is the folding base section of the main unit with the exception that the screens are not part of the system and the unit folds closed the opposite way to protect the top area of the unit.

2). Nomad: the second version is the unit without the screens and is used as a wireless Internet browser and PC. The main distinction is that the system uses external monitors or TV sets as the viewing source. This is accomplished via set-top video signal converter boxes that receive the video images from the Flip-Pad unit either via a direct cable connection or wirelessly. As such, the unit is the least expensive of the designs within the system.

3). Triad (SketchPad):

This version is the three-screen version whereas the main screen is oriented in the traditional landscape version, and the side-wing monitors are each half the size of the main screen and are then hinged to the left and right side of the main screen so that they can be folded closed to equally cover half of the screen each. And then be opened to double the screen size of the main screen. Furthermore, the systems main PC board and processor and accessory device bays all mounted behind the main screen in the unit's main housing. This unit contains built-in communications hardware such as the Flip-Pad Internet phone hardware (described previously) or industry standard technology, such as cellular or satellite connections.

The unit can then be docked with a separate expansion module that houses either a printer/fax/scanner/copier module or a satellite communications setup. This module also features a convenient top surface that can be used to install a keyboard (alphanumeric) or other necessary keys or buttons such as video editing or custom configured terminal controls, and or a large tablet surface for drawing.

4). Cinerama:

Is the scaled up version of the Triad in order to provide a combination large screen wall mounted high-end surround sound entertainment system and PC. This is the basis of the home network solution. This solution is basically a three-fold (Tri-Fold™ wall mounted PC that hangs on the wall or sits on a stand and offers the convenience and style of being folded closed to protect the screen when not in use. And then can be opened up to greatly increase the available screen real estate for viewing. The side wing monitors can be opened fully or angled inward for privacy and to surround the viewer/s with the video imagery, thus opening the proverbial door to new experiences such as introducing peripheral vision into the viewing experience. In this case imagine a viewer playing a video game that is plugged into the system. In this game, for example, the participant is assuming the role of a fighter pilot in an advanced tactical aircraft. For realism, it is currently known to employ surround sound techniques that present the audio equivalent of having another jet streak past the cockpit or to have the sound of bullets pass overhead. What is not known previously, is to have a home entertainment system that can angle the side viewing panels in a three-screen affixed contiguous arrangement to bring the participant's peripheral vision into the equation. This allows for unprecedented flexibility, and a virtual reality-like, experiences without the need for bulky helmets to be worn. Also the user is not confined within the virtual world, as is the case with the aforementioned helmets. It is known that many users of virtual reality helmets frequently get dizzy or suffer motion sickness as a result of not being able to see anything other than the fast moving images presented to their eyes via the helmet. This confining visual reality without the aid of the user being able to simply avert their gaze to some other fixed object in the real world for a moment to regain their composure is what typically leads to the effect of motion sickness. This is not the case with the Cinerama, since the user is free to look about to whatever they choose.

The ability to tie the audio and visual portions of the special effects is unprecedented and quite valuable since it is obvious, that in the real world the senses of sight and sound are closely intertwined in conveying complete information to the brain.

The unit also has expansion bays that let the user easily plug in a DVD module or zip drive, etc. for easy expansion like mobile PCs currently do. These expansion bays are very similar to the hot-dockable bays of the portable computer world. The difference is that this is the first time that they have been used to easily setup and expand a home entertainment/network system. This as opposed to the way the average consumer must buy a separate dedicated DVD player and then hook it up via a series of cables. This is usually a very cumbersome and time consuming process of installation often requiring professional assistance and is very cumbersome to then move the system at a later date.

With the Flip-Pad Cinerama, the system is simply hung on the wall, the side screens are then unclasped and opened and moved into place. The user then upgrades the system by plugging expansion modules directly into the face of the unit. This allows for example, DVD drives or a re-writable media of some sort (Zip/tape/CD/etc.), to be plugged directly into the expansion bays that are mounted on the system. This is far superior to the standard way of installing components to the average home entertainment system, where the DVD player or tuner, etc. is a self-contained device that is then connected to the system via cables to the other components in the system. This is a very cumbersome and space consuming way to establish a home entertainment system. The Cinerama is the first self-contained easy to upgrade large screen wall mounted PC/TV system in the world.

This is a first, and allows the user to gain the convenience and flexibility of this system architecture. Whereas it is a high resolution 3-piece LCD PC monitor, hung in the wall that has all of the necessary components of a PC (CPU, hard drive, etc.) and also has a built-in TV and am/fin tuner built-in the system then allows for all of the necessary components to a high-end home entertainment system to be plugged into the plug-and-play slots on the face of the machine. The unit has the added convenience of all of the speakers except the rear (front: left and right/Center/subwoofer) all conveniently built-in to the unit so that all that the installation requires is that the rear channel speakers be positioned for optimum sound and then be connected (cable or wireless). The user then connects the necessary inputs (cable/satellite/modem/etc.) and the outputs and plugs the unit into the standard AC power outlet. The system upon boot-up recognizes all of the devices in the system and sets them up accordingly. Furthermore, since it is a PC and not a TV alone, the unit can be setup to have password protection to limit viewing hours and access to mature programming to users with the correct password corresponding to their viewing age and access. The passwords and level of viewing access are set by the owner (parent), and is not an arbitrary rating system like the proposed “V” chip.

Speakers (Front & Rear):

As mentioned, the unit also has the speakers built-in for convenience. The front speakers are divided into the main channels of sound common to surround sound systems. The front speakers top and bottom mounted to the outside edge of the side monitor frames. The front voice coil speaker and subwoofers are mounted above and below the main screen of the unit. This allows for both proper positioning of the sound sources and also allows for sound when the screens are folded.

The rear speakers are then connected to the system either via a cabled or wireless connection.

Input/Output:

The system cabinet also houses additional expansion slots for a host of devices such as Zip drives and other storage mediums. The unit also features a host of ports for video input such as satellite, cable, 1394 “firewire” for camcorder connections, keyboard, mouse, USB, Bluetooth, IR, etc.

DVD/CD Jukebox:

The system can also be connected to a proprietary 100 discs writeable DVD/CD jukebox. By adding this to the system the unit can house up to 100 DVD movies and music CDs that can be categorized and viewed on screen per selection topic, i.e. Action movies, romance, comedy, etc.

Surround Visuals:

The unit's ability to adjust the angles of the side screens from fully closed to beyond 180-degrees opened against the wall. This provides the opportunity to angle the screens, for other purposes than just the act of opening and closing. Modern surround sound systems convince the ear of the viewer that the sound is coming from all directions as in real life. The problem is that the video source is a flat screen and confuses the listening/viewing experience. The Cinerama is able to re-balance the visual/audio equation by angling the screens at less than or more than 0.180-degrees to provide unique visual effects including the first ever use of peripheral vision, much like the 3-D theaters.

Home Network with Echo Location of Peripherals:

The system is also the hub of the first transportable smart-house home network system. In a traditional smart-house the system is hard-wired into the structure, when the homeowner moves, they must leave the system behind.

When using the Flip-Pad Cinerama the user can simply hang the system on the wall, open the screens to the desired angle, plug the system in, and then boot it up. Upon using the accessory appliance control modules, the user then plugs them between the appliances between the appliances power cord and then plugs the control modules AC power plugs into the standard wall outlet. Upon doing so, the main unit uses the existing electrical wiring of the house as the signal conduit and “echo” locates the appliances via the control modules and plots them automatically on the house grid. This is achieved, when the main unit sends out a signal, and when it is received by the control modules at the appliance location, the module “echoes” the signal back to the main unit which is then plot by its coordinates in the system grid. The user can then further define the usage patterns such as in the case of a lamp or coffee maker by having them turn on at a set time. This allows for a completely portable self-contained smart-modular digital home network. The unit will also allow for the smart-module technology to be built into appliances that do not typically require a cord, such as with a dishwasher. This system's control modules can be further extended to control appliances directly, by being hard-wired directly to the main junction box (circuit breaker) in the structure, via custom designed circuit breakers that work with the system.

Cinerama Supplement

Picture-in-Picture on the Side Monitors:

What is currently known in modern television sets is the ability to feed a secondary or even multiple video feeds into the main unit and view them in small windows overlayed on the main viewing screen. Since there is only one set or screen in a TV set, much like single screen PC setups, this can be confusing and of little value to the consumer. The Cinerama's unique 3-screen arrangement provides for the screen area to allow the user to watch a program full-screen on the central monitor, while brining up other programs or information on the side areas without interrupting the main viewing area. This is even more useful since the user can then highlight one of the programs running in reduced windows on the side, and bring them up full screen on the central viewing area at their discretion. For example, the user could be watching a football game while the stock quotes and news are running in user selectable windows on the side monitors, in this case, the commercial comes on and the user can drag the side window to the central area and blow it up full screen. Once the commercial is over, the window of the game can resume center stage. This is also useful for people who work out of their home and want to view the Internet, a television program, their stock quotes and any other information. This truly creates the world's first totally integrated Information appliance.

Video Phone & Video Conferencing:

The unit will also be upgradeable with a full-motion video camera or can use an existing camcorder as the video feed to enable large screen video conferencing over the unit. This will allow for first ever, large screen in-home.

1. (canceled)

2. In a portable, notebook or portable computer having a main frame and display-screen means,
the improvement comprising:
said display-screen means comprising pivot-mounting means operatively connected to a portion of said main frame; said display-screen means further comprising at least one independently pivotal display screen rotatably coupled to said main frame via said pivot-mounting means;
said pivot-mounting means mounting said display screen for rotation in at least two planes, said at least two planes being perpendicular to each other;
said pivot-mounting means comprising a mounting arm having a first end connected to a portion of said main frame, and a second end connected to a portion of said display-screen, and further comprising a first pivot mount at said first end for pivotally mounting said display-screen to said main frame for movement in one said plane, and a second pivot mount at said second end for pivotally mounting said display-screen for movement in both said planes;
said second pivot mount allowing rotation of said display-screen in the other of said planes so that said display screen may assume one of a portrait orientation and landscape orientation.

3. The portable, notebook or portable computer according to claim 2, wherein each of said planes is a vertical plane.

4. The portable, notebook or portable computer according to claim 2, wherein said main frame comprises a hollow compartment in which said display-screen may be stored; each of said first and second pivot mounts allowing said mounting arm to rotate in said one plane in order to position said display-screen over said hollow compartment of said main frame for storage and transport.

5. The portable, notebook or portable computer according to claim 4, wherein said at least two planes are vertical planes.

6. The portable, notebook or portable computer according to claim 2, wherein said main frame comprises a bottom surface, and angular support means connected to said bottom surface; said angular support means being movable for providing a support to said main frame for positioning said bottom surface of said main frame in an upwardly-tilted orientation, whereby said display-screen may be oriented for display during use.

7. The portable, notebook or portable computer according to claim 4, wherein said display screen serves as a top cover to said hollow compartment and, therefore, also to said main frame, when said display screen is positioned over said hollow compartment during storage.

8. The portable, notebook or portable computer according to claim 7, wherein further comprising a keyboard, said keyboard being stored in said hollow compartment of said main frame during storage and transport before said display screen is rotated over said hollow compartment.

9. In a portable, notebook or portable computer having a main frame and display-screen means,
the improvement comprising:
said display-screen means comprising pivot-mounting means operatively connected to a portion of said main frame; said display-screen means further comprising at least one independently pivotal display screen rotatably coupled to said main frame via said pivot-mounting means;
said pivot-mounting means mounting said display screen for rotation in at least one plane, and comprising a pivot mount providing at least 180 degrees of movement to said display-screen;
said main frame comprising a horizontal hollow compartment;
said pivot mount allowing said display-screen said at least 180 degree of movement in order to position said display-screen over said hollow compartment, in order to position said display-screen at least one of an acute angle and an obtuse angle with respect to said horizontal hollow compartment, and in order to position said display-screen at a 180-degree angle with respect to said horizontal hollow compartment;
said main frame also comprising a bottom surface, and angular support means connected to said bottom surface; said angular support means being movable for providing a support to said main frame for positioning said bottom surface of said main frame in an upwardly-orientated orientation when said display screen has been rotated to said 180-degree position relative to said hollow compartment, whereby said display-screen and said hollow compartment are substantially coplanar when in said upwardly-orientated orientation;
said hollow compartment, when in said upwardly-orientated orientation serving as a stand for holding paper, and the like, for use with desk-top computers.

10. The portable, notebook or portable computer according to claim 9, wherein said display screen serves as a top cover to said hollow compartment and, therefore, also to said main frame, when said display screen is not being used.

11. The portable, notebook or portable computer according to claim 10, further comprising a removable keyboard, said removable keyboard being stored in said hollow compartment of said main frame during storage and transport, before said display screen is rotated over said hollow compartment to serve as a cover.

12. In a portable, notebook or portable computer having a main frame, a keyboard, and display-screen means, the improvement comprising:
said display-screen means comprising pivot-mounting means operatively connected to a portion of said main frame; said display-screen means further comprising at least one independently-pivotal display screen rotatably coupled to said main frame via said pivot-mounting means;
said pivot-mounting means mounting said display screen for rotation in at least one plane, and comprising a pivot mount providing at least one degree of freedom of motion to said display-screen;
said main frame comprising a hollow compartment;
said pivot mount allowing said display-screen to be over said hollow compartment in order for said display-screen to serve as a cover to said hollow compartment, and, therefore, to said main frame; said pivot mount also allowing said display-screen to be positioned at least one of an acute angle, an obtuse angle, and an approximately 180-degree angle with respect to said hollow compartment;
said main frame also comprising a bottom surface, and angular support means connected to said bottom surface; said angular support means being movable for providing a support to said main frame for positioning said bottom surface of said main frame in an upwardly-orientated orientation when said display screen has been rotated to said approximately 180-degree position relative to said hollow compartment.

13. The portable, notebook or portable computer according to claim 12, further comprising a removable keyboard, said removable keyboard being stored in said hollow compartment of said main frame during storage and transport.

14. In a portable, notebook or portable computer having a main frame, and display-screen means, the improvement comprising:
said display-screen means comprising first pivot-mounting means operatively connected to a portion of said main frame; said display-means comprising an upper and a lower display-screen, each said display-screen having a lower edge-surface and an upper edge-surface; said lower display-screen having mounted to its said lower edge-surface said first pivot mounting means; said first pivot mounting said first lower display-screen for at least partial rotation relative to said portion of said main frame;
said display-screen means further comprising second pivot-mounting means connected to said lower edge-surface of the upper display-screen and said upper edge-surface of said lower display-screen;
said second pivot-mounting means allowing rotation of said upper display-screen relative to said lower display-screen in one direction and preventing rotation in the other, opposite direction, whereby said upper display-screen may be oriented with said lower display-screen in the same plane in order to provide an enlarged display area, and whereby said upper display-screen may be oriented facing away from said lower display-screen so that visual displays may be viewed from either side; said upper edge-surface of said upper display-screen serving as a support resting on a support-surface therebelow for said upper and lower display-screens when said display-screens are oriented facing away from each other.

15. The portable, notebook or portable computer according to claim 14, wherein said first pivot-mounting means mounts said lower display-screen to said portion of said main frame for approximately 180 degrees rotation, whereby said main frame may serve as the support-surface upon which rests said upper edge-surface of said upper display-screen.
